(19) United States
(12) Patent Application Publication
(10) Pub. No.: US 2008/0100457 A1
(43) Pub. Date: May 1, 2008

(54) Product Security

(76) Inventor: Andrew Gray, York (GB)

Correspondence Address: KLARQUIST SPARKMAN, LLP, 121 SW SALMON STREET, SUITE 1600, PORTLAND, OR, 97204, US

(21) Appl. No.: 11/628,436

(22) PCT Filed: May 31, 2005
(86) PCT No.: PCT/GB05/02139

§ 371 Date: Aug. 10, 2007

(30) Foreign Application Priority Data
Jun. 4, 2004 (GB) 0412498.8

(51) Int. Cl. G08B 13/14; G08B 1/08

(52) U.S. Cl. 340/572.9; 340/539.21

(57) ABSTRACT

An apparatus and method for improving security are disclosed. The apparatus includes a case provided with an aperture, the aperture being closable by a clasp, the clasp being operable by a trigger which operates in response to a radio frequency (RF) signal.

This invention relates to a novel security and to methods related thereto. In particular, but not exclusively, the present invention relates to a security tag which may be securely fitted to an article per se.

Conventional security for products in the retail environment has tended to be a simple form of locking the product to a rigid structure or if the goods are to be protected they can be connected to a store alarm where, if the goods are taken, the alarm is triggered.

There are however a number of problems associated with known security methods and devices. Notably when products are locked within a retail environment it is a time consuming process to unlock the product so that a potential consumer can examine that product closely. Also on the occasion that a product is stolen an alarm is triggered only within a retail environment. Once a thief has moved away from such an environment there is no longer any indication that property held by that person is stolen property.

It is an aim of the present invention to at least partly mitigate the above-mentioned problems.

It is an aim of embodiments of the present invention to provide a security device which may be releasably secured to a product which will be retained with a product if it is stolen and issue an audible and/or visible alarm.

Thus, according to the invention we provide a security apparatus comprising a case provided with an aperture, the aperture being closable by a clasp, the clasp being operable by a trigger which operates in response to a radio frequency (RF) signal.

In the present invention there is provided a case that may be securely fixed to an item, which having a receiver will sense if it is within range of a given transmitter. In the event that the item is taken beyond the range of the transmitter then an alarm will sound from within the case. There is further provided a motion sensor that will allow the electronics to rest while not being moved, to save power. There will also be provided a clasp that will be used to fix the case to the object and a further method using a cord that may be attached to the product and may have an anti-force connection to the alarm system within the case. This system may be used to protect products within a retail environment where one transmitter may offer a ‘safe zone signal’ to a plurality of receivers within secure cases, or be used by an individual to protect a single item.

According to a further aspect of the invention we provide a security system which comprises,
a security apparatus, as herein described; and
a radio frequency transmitter.

The system of the invention is advantageous that, inter alia, the radio frequency transmitter can be positioned remotely from the security apparatus.

The present invention is designed to turn the location of the alarm from being attached to the store building to being attached to the product to be protected, the advantage being that, inter alia, if the product cannot be removed from the alarm case, the person removing the item can be easily identified as the thief.

The present invention provides for a transmitter; in the preferred embodiment this will be in the form of a radio frequency transmission. The signal offered by the transmitter may be received by a plurality of receivers within an area or ‘safe zone’. The receiver is controlled by a controller that is linked to a motion sensor and further sensors within the case that will allow the alarm to respond to a number of adverse experiences. To conserve power the system will be programmed to remain in a state of very low power use until the motion sensor senses movement then the controller will then wake the receiver to seek the coded transmission from the transmitter. As long as the receiver can still receive the transmission it will not operate the alarm. Should the receiver start to miss some of the transmissions then it will start to beep. If the transmissions become weaker still, indicating that the item is being taken further away from the intended safe zone created by the output signal of the transmitter, then the alarm will go into full volume bleeping state. At this stage it is anticipated that the person in control of the product with the case attached will either return or drop the item. There may be provided a hand-held transmitter that will stop the alarm sounding, which will be held by staff members only.

The present invention provides for a clasp that will go around the item to be protected. It is anticipated that there will be a further sensor (not shown) provided so that any flexing or forcing of the clasp will automatically put the alarm into full volume alert. In the preferred embodiment there may also be provided a further attaching means so that the case may be securely connected to the product that it is intended to protect. This may take the form of a steel cord, or a cord of a similarly robust material, that will be connected inside the case in such a way that should there be any attempt to pull the case away from the product, the alarm will operate at full volume. The cord may have a variety of external ends in order to connect to other items. For example the cord may have a steel washer or similar so that a secure fixing may connect it to an item, such as electrical goods by means of a secure screw fixing. There may also be provided a spike and magnetic releasable cone that are common for the protection of clothing, or a locking means such as a Kensington lock that is commonly used on laptop computers. The present invention includes a connection method herein shown as a spring. In the preferred embodiment there is a biasing means which presses the collar securing one end of the cord onto a switch sensor. If the cord is pulled then the force will compress the spring and the collar will lose contact with a sensor and operate the alarm at full volume.

In the present invention there is provided a controller that will allow the electronics to go from a low power use ‘sleep’ mode to an armed mode when the case is being moved. If the unit is then moved to the outer edge of the ‘safe zone’ the unit will adopt a warning slow beeping mode. The unit will then adopt a full alarm mode when the case is taken away from the transmitter or if a forceful attempt is made to separate it from the product being protected.

There is a further aspect of the present invention where there is provided a key to unlock the clasp to disconnect the case from the product which it is intended to protect. There are many lock and key systems some of which are more sophisticated and costly than others. In the present invention we have provided a key and lock that is simple in appearance yet will only work with the use of a small powerful magnet within the body of the key. This is a novel approach to a lock mechanism where the magnet in the key attracts a steel element within the lock so that only when the special key is inserted will the latch of the lock be engaged and operate. As small magnets of this nature are not normally used in keys it is anticipated that this will provide an extra level of security. However this will not offer any specific security to different units; i.e. one key will fit all that are produced. It may be appreciated that the key is required to open the clasp mechanically; the alternative may be a more costly solenoid or motor. However as there is already provided a receiver in the design, the present invention may include a controller that will recognise a specific release code. If the key is inserted prior to the release code being received then the alarm will sound. In order to gain more time for the owner to protect against a thief with a key there could be provided a key cover that will trigger the alarm prior to the key being inserted. In this case the alarm will be triggered on movement of the cover. The alarm will not operate if it is deactivated by the correct code transmitted from a handheld transmitter with a specific code for that unit. As there is a large range of coded messages that can be received it will be simple to select new ones for new customers. So by way of example a key holder from shop a. will not be able to operate the system in shop b. Should the device be used by members of the public the owner of one unit will not be able to de-activate the unit of another.

The present invention includes a printed circuit board (pcb) on which the electronic components are located. These will include a radio frequency receiver with an antenna, a programmable chip with the software that governs the operation of the device, a battery, a motion sensor and at least one switch that will operate in an open or closed way to monitor the use of the key; further switches may be used to monitor stress on the cable connection into the case or wrenching of the clasp to detect an attempt at forced disconnection with the product that it is there to protect.

It will be understood by those who design electronic components of this nature that there is normally an objective to conserve the power used by the battery. To this end there is provided a motion sensor to ‘awaken’ the unit—a stationary unit is very unlikely to be stolen. In this way the rest of the electronics can be placed in a state of very low power use until the motion sensor alerts the system that there is movement and then the receiver can be turned on to sense if it can receive the ‘safe zone’ transmission.

In a further aspect of the invention there is provided a clasp that closes around a part of the product to be protected to form a secure connection. The clasp moves from an open to a closed position, being held on a ratchet. This allows the clasp to hold onto a greater range of items as it can hold around any reverse angle on the product to be protected. In a further development of the clasp arrangement there may be provided a spike to go through material such as cloth so that the unit can be fixed to a wider range of products.

In a further aspect of the present invention there is a case that is made in two halves and secured together by means of secure fixings. The access to the rotatable tops of the fixings will be concealed by push fit plugs that will need to be drilled out before the fixings can be removed.

It may be understood that the problem that this invention is intended to solve is the separation of an item of value from the owner. It should therefore be clear that this may be true for retailers and their goods but it may also be true for members of the public particularly when they are travelling. Therefore people who carry items of value such as a laptop, briefcase, handbag or the like may keep the small transmitter on their person and the alarm unit on their property that is to be protected. Not only will this help them protect their goods from theft but also help them not to leave their valuables behind.

The invention will now be described, by way of example only, with reference to the accompanying drawings in which:

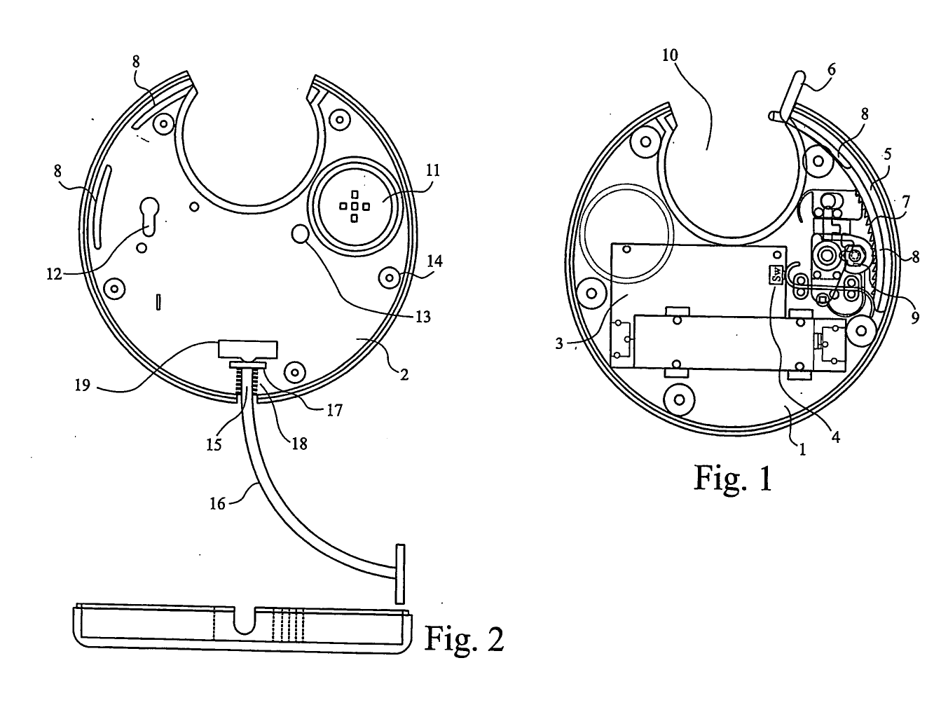

FIG. 1. shows an interior view of the base of the case;

FIG. 2. shows the interior view of the lid of the case;

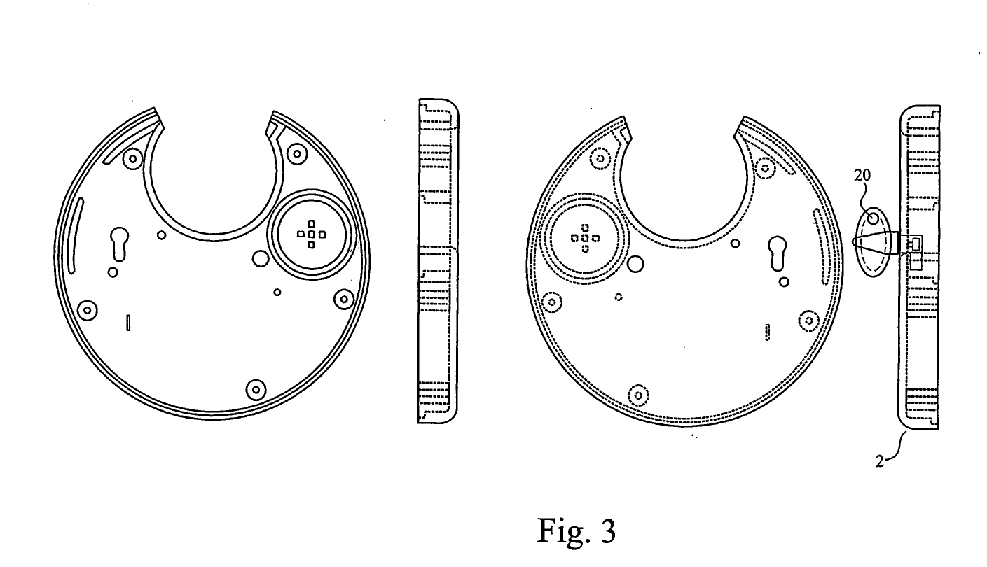

FIG. 3. shows a cutaway view of the case lid with the key;

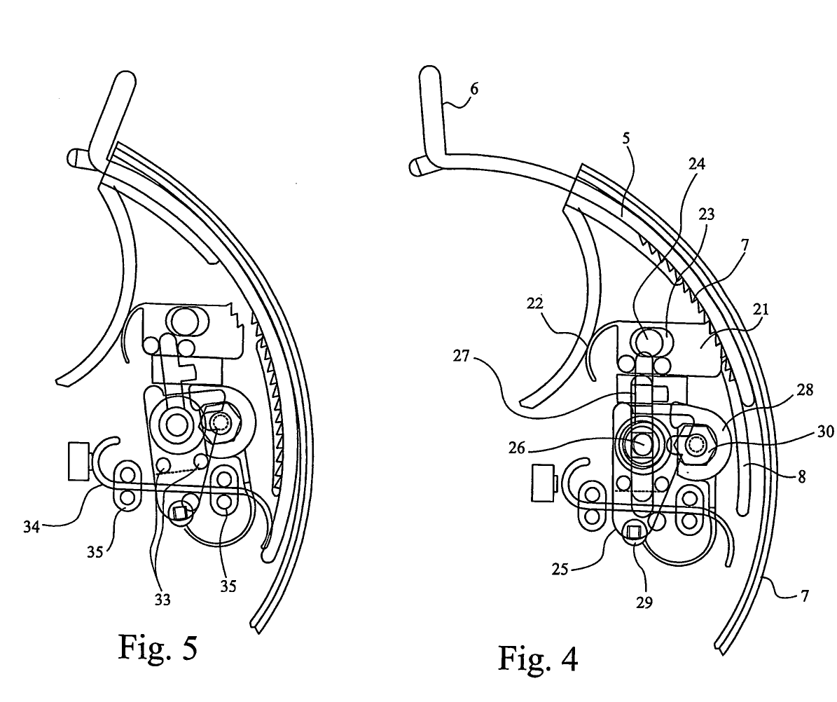

FIG. 4. shows the clasp in a closed position;

FIG. 5. shows the clasp in the open position;

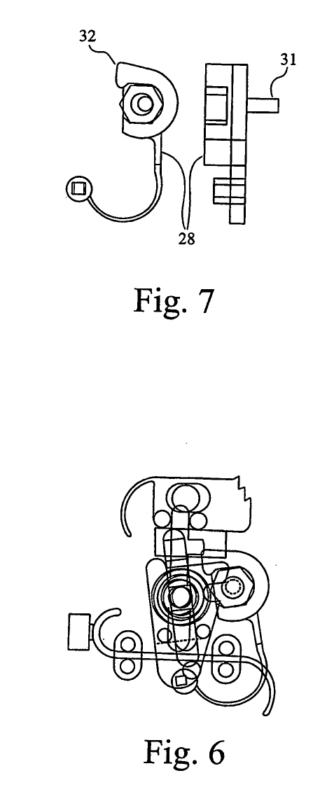

FIG. 6. shows the magnetic key operable lock being used without the magnet place; and

FIG. 7. shows the parts of the magnetic key operable lock.

The following numbering scheme will be adhered to:
1. Case base
2. Case lid
3. PCB
4. Switch—clasp
5. Clasp.
6. Clasp handle.
7. Clasp ratchet.
8. Clasp retaining wall.
9. Lock.
10. Space, being enclosed by clasp.
11. Piso Sounder
12. Keyhole.
13. Led hole.
14. Fixing hole.
15. Additional fixing means.
16. Connection cord.
17. Collar.
18. Spring.
19. Switch—for add. Fix.
20. Key.
21. Ratchet pawl.
22. Biasing means for 21.
23. Slot for 21.
24. Pin in case for 21.
25. Swivel block.
26. Post for swivel block.
27. Lever arm.
28. Spring catch.
29. Post on swivel block.
30. Steel item in 28.
31. Leg of 27.
32. Pushing face of 27.
33. Posts on 25.
34. Switch lever.
35. Guide posts for 34.

In the present invention there is provided a case of which 1 is the base (FIG. 1), Base 1 contains the pcb 3 on which is placed (all the electronic components are of known type and are not shown) the motion sensor, the radio frequency receiver, the programmable chip, the battery, an L E D warning light to show battery strength, and other basic electronic components. Further there is a switch 4 to turn the system off when the key is in place and the clasp is fully open.

Within the base there is also provided clasp member 5 with handle 6 and ratchet 7 which is retained in the case in such a way that it can move from an open to closed position between the sidewall of the case and retaining walls 8.

There is further provided a lock 9 which is operated by a magnetic key, the components of which are more fully described with reference to FIGS. 6 and 7. With the use of the key the clasp may be opened to allow a part of the item to be protected to be enclosed within area 10 when the clasp is in the closed position or is locked around part of the item to be protected in such a way that it cannot easily be removed.

Retained within case lid 2 (FIG. 2) is the alarm unit which is shown here as a piso disc 11. There is further provided a key hole 12, hole for L E D battery indicator 13 and five fixing points for screw fixings 14. To facilitate additional fixing means from the unit to the property protected there is provided additional fixing means 15. having connection cord 16. This may at its external end have a number different means to fix appropriately to other items requiring protection. On the internal end of cord 16 there is a retaining collar 17 which is pressed by biasing means 18, here shown as a coil spring, to press against switch 19. If there is any lateral force placed upon cord 16 then the contact between the collar and the switch will be broken and the unit will alarm immediately. This will allow for general handling but any force that may be assumed to be an effort to separate the unit from the item to be protected will trigger the alarm for a given period of time.

FIG. 3 shows a cutaway side view of case lid 2 with the magnetic key 20 in place.

FIG. 4. shows the clasp in a generally closed position where ratchet 7 is engaged by ratchet pawl 21 which is pressed towards the ratchet on clasp 5 by biasing means 22. It is permitted a required amount of lateral movement by virtue of slot 23 which is placed on post 24 being part of case 1.

The lock is made up of three main parts a swivel block 25 which is retained on post 26, the lever arm 27 which shares post 26 and the spring catch 28 which is positively located on block 25 by means of a square post 29. The spring catch retains an item with ferrous content here shown as a steel nut 30. The parts are so arranged that when the key is inserted steel 30 is attracted by the magnet within key 20 which draws the spring catch closer to swivel block 25 so that leg 31 and pushing face 32 (see FIG. 7) prevent any movement between the swivel lock and lever arm 27, enabling the end of the lever arm to act on the ratchet pawl to disengage from ratchet teeth 7. The key comes between the posts 33 on swivel block 25 and does not act directly upon the lever arm, which can without the use of the magnet rotate independently of the swivel block. If there is no magnet in place then there is no rigidity between swivel block 25. and the lever arm 27 and the key or any other implement will be unable to operate the lock.

FIG. 5 shows the key turned with the magnet in place where the lever arm is able to withdraw the ratchet pawl and the clasp can be moved. When the clasp is open the internal tip of the clasp comes up against the switch lever 34 which is moved laterally against switch 4. Switch lever 34 is guided in its movement between the four guide posts 35 which are part of base 1.

For clarity FIG. 6 shows the lock rotated by a key or other implement without the inclusion of the magnet. The lever arm does not rotate therefore the ratchet arm does not disengage.

FIG. 7 shows two views of spring catch 28 where leg 31 rests against swivel block 25 and push face 32 acts against lever arm 27.

The programmable chip on the pcb will determine whether the alarm should operate depending on the code and strength of the signal being received.

The above-mentioned examples have been given by way of example only. It will be understood that modifications may be made to the specifically described component parts without departing from the scope of the present invention.

1. A security apparatus comprising a case provided with an aperture, the aperture being closable by a clasp, the clasp being operable by a trigger which operates in response to a radio frequency (RF) signal.

2. A security apparatus according to claim 1 wherein the case may be releasably secured to an item.

3. A security apparatus according to claim 1 wherein the apparatus is arranged to sense if it is within range of a given transmitter and in the event that the item is taken beyond the range of the transmitter then an alarm will sound from within the case.

4. A security apparatus according to claim 1 further comprising a motion sensor.

5. A security apparatus according to claim 1 wherein the apparatus operates in a low power mode while not being moved.

6. A security apparatus according to claim 1 further comprising a clasp or a cord that will be used to fix the case to an object.

7. A security apparatus according to claim 6 wherein the clasp or cord has an anti-force connection to the alarm system within the case.

8. A security apparatus according to claim 1 wherein the apparatus is locatable by an individual to protect a single item.

9. A security system which comprises,
the security apparatus of claim 1; and
a radio frequency transmitter.

10. A security system according to claim 9 wherein the system may be arranged to protect products within a retail environment where one transmitter may offer a ‘safe zone signal’ to a plurality of receivers within secure cases.

11. A security system according to claim 9 wherein the signal transmitted by the transmitter may be received by a plurality of receivers within an area or ‘safe zone’.

12. A security system according to claim 11 wherein the security apparatus comprises an alarm and the receiver is controlled by a controller that is linked to at least one motion sensor and optionally at least one further sensor within the case that will allow the alarm to respond to a number of adverse experiences.

13. A security system according to claim 9 wherein the security apparatus comprises an alarm and if the receiver can still receive the transmission it will not operate the alarm.

14. A security system according to claim 13 wherein if the receiver misses one or more of the transmissions from the transmitter then it will activate the alarm.

15. A security system according to claim 14 wherein if the transmissions become weaker still, indicating that the item is being taken further away from the intended safe zone created by the output signal of the transmitter, then the alarm will enter full volume mode.

16. A security system according to claim 15 wherein the system is provided with a hand-held transmitter that will stop the alarm sounding.

17. A security system according to claim 9 wherein a clasp is provided that will go around an item to be protected.

18. A security system according to claim 9 wherein the security apparatus comprises an alarm and a further sensor is provided so that any flexing or forcing of the clasp will automatically put the alarm into full volume mode.

19. A security apparatus according to claim 2 further comprising attaching means for securely connecting the case to a product that it is intended to protect.

20. A security apparatus according to claim 19 wherein the attaching means takes the form of a steel cord that will be connected inside the case in such a way that should there be any attempt to pull the case away from the product, an alarm will operate at full volume.

21. A security apparatus according to claim 20 wherein the cord may have a variety of external ends in order to be connectable to a range of items.

22. A security apparatus according to claim 20 wherein the cord has a steel washer so that a secure fixing may connect it to an item, by means of a secure screw fixing.

23. A security apparatus according to claim 19 further comprising a spike and magnetic releasable cone, or a locking means.

24. A security apparatus according to claim 1 further comprising a connection method which comprises a spring.

25. A security apparatus according to claim 1 further comprising a biasing means which presses a collar securing one end of the cord onto a switch sensor.

26. A security apparatus according to claim 25 wherein if the cord is pulled then the force will compress the biasing means and the collar will lose contact with a sensor and operate an alarm at full volume.

27. A security apparatus according to claim 2 further comprising a key to unlock the clasp to disconnect the case from the product which it is intended to protect.

28. A security apparatus according to claim 27 wherein there is provided a lock operable to work with the use of a magnet within the body of the key.

29. A security apparatus according to claim 28 wherein the magnet in the key attracts a magnetic element within the lock so that only when the key is inserted will the latch of the lock be engaged and operate.

30. A security apparatus according to claim 29 wherein the magnet provides an extra level of security.

31. A security apparatus according to claim 30 wherein a key is required to open the clasp mechanically or a solenoid or motor may be used.

32. A security apparatus according to claim 1 further comprising a controller that will recognise a specific release code.

33. A security apparatus according to claim 32 further comprising a key cover that will trigger an alarm prior to the key being inserted.

34. A security apparatus according to claim 33 wherein the alarm will not operate if it is deactivated by the correct code transmitted from a handheld transmitter with a specific code for that unit.

35. A security apparatus according to claim 1 further comprising a printed circuit board (pcb) on which the electronic components are located.

36. A security apparatus according to claim 35 wherein the electronics components include a radio frequency receiver with an antenna, a programmable chip with the software that governs the operation of the device, a battery, a motion sensor and at least one switch that will operate in an open or closed way to monitor the use of the key.

37. A security apparatus according to claim 35 wherein further switches may be used to monitor stress on the cable connection into the case or wrenching of the clasp to detect an attempt at forced disconnection with the product that it is there to protect.

38. A security apparatus according to claim 1 wherein the clasp is operable to move from an open to a closed position, being held on a ratchet.

39. A security apparatus according to claim 1 wherein a spike is provided to go through material such as cloth so that the unit can be fixed to a wide range of products.

40. A security apparatus according to claim 1 wherein the apparatus is adapted to fit a laptop, briefcase, handbag or the like and a user may keep the small transmitter on their person and the alarm unit on their property that is to be protected.

41. A method of securing an item comprising using the apparatus according to claim 1 or the system according to claim 9.

42-43. (canceled)
